(19) United States
(12) Patent Application Publication
(10) Pub. No.: US 2012/0046909 A1
(43) Pub. Date: Feb. 23, 2012

(54) AIR CONDITIONING SYSTEM OVERALL EFFICIENCY CALCULATING DEVICE AND METHOD

(75) Inventor: Ryouta Dazai, Tokyo (JP)

(73) Assignee: YAMATAKE CORPORATION, Tokyo (JP)

(21) Appl. No.: 13/207,683

(22) Filed: Aug. 11, 2011

(30) Foreign Application Priority Data
Aug. 19, 2010 (JP) 2010-183784

(51) Int. Cl. G06F 15/00

(52) U.S. Cl. 702/182

(57) ABSTRACT

An indoor load is calculated from an indoor entropy of a controlled room, a supply air entropy of conditioned air that is supplied into the controlled room, and the amount of supply of the conditioned air that is supplied into the controlled room (indoor load=|indoor entropy−supply air entropy|×supply air flow rate). An overall efficiency for the air-conditioning system is calculated from the calculated indoor load and the total value for the amount of energy used by heat source equipment, heat source auxiliary equipment, and an air conditioner (the primary energy equivalent value thereof) (air-conditioning system overall efficiency=Σ indoor load/Σ (heat source energy usage amount+heat source auxiliary equipment energy usage amount+air conditioner energy usage amount)).

### CROSS REFERENCE TO RELATED APPLICATIONS

The present application claims priority under 35 U.S.C. §119 to Japanese Patent Application No. 2010-183784, filed Aug. 19, 2010, which is incorporated herein by reference.

### FIELD OF TECHNOLOGY

The present invention relates to an air-conditioning system overall efficiency calculating device and method for calculating the overall efficiency of an air-conditioning system from a load within a room.

### BACKGROUND OF THE INVENTION

Conventionally, a metric known as the heat source overall efficiency has been used as a metric for evaluating the amount of energy consumed by a heat source (See, for example, Architectural Institute of Japan Seminar Abstracts (Tohoku), August 2009, “Structure of a High-Efficiency Heat Source System at Sony City,” SUGIYAMA, Hiromi, “8. Air-Conditioning Operating and Usage Improvements, Results, and Evaluations”). This heat source overall efficiency is expressed by Equation (1), below:

Heat source overall efficiency(ζ)=amount of heat processed by the heat source/(amount of heat source energy used+amount of heat source auxiliary equipment energy used) (1)

Note that in Equation (1), if the heat source equipment runs on natural gas, then the amount of heat source energy used is a value wherein the amount of natural gas consumed by the heat source equipment is converted into a primary energy equivalent value, where the amount of energy used by the heat source auxiliary equipment is the amount of electricity consumed by the heat source equipment, the primary pump, the cooling water pump, and the like, converted into a primary energy equivalent value.

On the other hand, in modern office buildings, and the like, often the buildings require cooling airflows even in the winter, due to increases in office automation equipment and improvements in thermal insulation performance. Given this, cooling through the use of outdoor air during the winter and during spring/autumn can be considered. FIG. 10 and FIG. 11 show examples of conventional air-conditioning systems. FIG. 10 is an example of an air-conditioning system incapable of performing outdoor-air cooling, and FIG. 11 is an example of an air conditioning system capable of performing outdoor-air cooling.

An air-conditioning system incapable of performing outdoor air cooling is illustrated in FIG. 10. In FIG. 10, 1 is heat source equipment (water chilling/heating equipment) that that runs on gas to produce chilled water and heated water; 2 is a primary pump that is provided as auxiliary equipment in the circulating path of the chilled/heated water from the heat source equipment 1; 3 is a reciprocating header; 4 is a reciprocating water pipe; 5 is an FCU (fan coil unit) that receives a supply of chilled/heated water that is sent through the reciprocating water pipe 4 through the reciprocating header 3 from the heat source equipment 1; 6 is a return water pipe; 7 is a return header for returning the chilled/heated water that is sent through the return water pipe 6 after heat exchange by the FCU 5; 8 is a bypass pipe that passes through the reciprocating header 3 and the return header 7; 9 is a controlled room that receives a supply of conditioned air from the FCU 5; is a temperature sensor for measuring the indoor temperature of the controlled room 9; and 11 is air conditioning controlling equipment. The FCU 5 is provided with a water chilling/heating coil 5-1, a fan 5-2, and a chilled/heated water valve 5-3.

In this air-conditioning system, the circulating water that is compressed by the primary pump 2 is made into chilled/heated water of a prescribed temperature by the heat source equipment 1, arrives at the reciprocating header 3, and is sent through the reciprocating water pipe 4 to the FCU 5. After this, heat is exchanged at the FCU 5, and the chilled/heated water is returned through the return water pipe 6 to the return head 7, and is again put under pressure by the primary pump 2, to circulate through the path described above.

Additionally, the air conditioning controlling device 11 inputs a measured value tpv for the indoor temperature from a temperature sensor 10, and controls the inverter power (INV power) to the fan 5-2 and the degree of opening of the chilled/heated water valve 5-3 in the FCU 5 to cause the measured value tpv of the indoor temperature to go to a setting temperature tsp. That is, the amount of chilled/heated water that is fed to the heating/cooling water coil 5-1 from the heat source equipment 1, and the speed of rotation of the fan 5-2 are controlled to control the temperature of the conditioned air (the supply air temperature) and the supply rate of the conditioned air (the supply air flow rate) that is supplied from the FCU 5 to the controlled room 9. Moreover, the air conditioning controlling device 11 also sends operating mode instructions (cooling/heating mode instructions) and start/stop instructions to the heat source equipment 1 depending on the current load conditions. The primary pump 2 starts and stops in coordination with the heat source equipment 1.

An air-conditioning system able to perform outdoor air cooling is illustrated in FIG. 11. In FIG. 11, 12 is an air conditioner; 13 is a chilled/heated water valve; 14 is an outdoor air damper; 15 is a return air damper, and 16 is an air conditioning controlling device. The air conditioner 12 is provided with a water chilling/heating coil 12-1 and a fan 12-2. The air conditioner 12 draws in outdoor air OA through the outdoor air damper 14, and draws in return air RA, which is returned from the controlled room 9 through the return air damper 15. Note that those codes that are identical to those in FIG. 10 indicate structural elements that are identical or equivalent to structural elements that were explained in reference to FIG. 10, and explanations thereof are omitted.

In this air-conditioning system, the circulating water that is compressed by the primary pump 2 is made into chilled/heated water of a prescribed temperature by the heat source equipment 1, arrives at the reciprocating header 3, and is sent through the reciprocating water pipe 4 to the air conditioner 12. After this, heat is exchanged at the air-conditioner 12, and the chilled/heated water is returned through the return water pipe 6 to the return head 7, and is again put under pressure by the primary pump 2, to circulate through the path described above.

Additionally, the air conditioning controlling device 16 inputs a measured value tpv for the indoor temperature from a temperature sensor 10, and controls the inverter power (INV power) to the fan 12-2 and the degree of opening of the chilled/heated water valve 13 to cause the measured value tpv of the indoor temperature to go to a setting temperature tsp. That is, the amount of chilled/heated water that is fed to the heating/cooling water coil 12-1 from the heat source equipment 1, and the speed of rotation of the fan 12-2 are controlled to control the temperature of the conditioned air (the supply air temperature) and the supply rate of the conditioned air (the supply air flow rate) that is supplied from the air conditioner 12 to the controlled room 9.

Additionally, the air conditioning controlling device 16 inputs the outdoor temperature tout, and evaluates whether or not outdoor-air cooling is possible. If the evaluation is that outdoor-air cooling is possible, then it adjusts the mixing ratio of the outdoor air and the return air into the air conditioner 12 through controlling the openings of the outdoor air damper 14 and the return air damper 15, to use the cold outdoor air to perform the cooling. Moreover, the air conditioning controlling device 11 also sends operating mode instructions (cooling/heating mode instructions) and start/stop instructions to the heat source equipment 1 depending on the current load conditions. The primary pump 2 starts and stops in coordination with the heat source equipment 1.

In the air-conditioning systems illustrated in FIG. 10 and FIG. 11, the total efficiency ζ of the heat source, described above, is expressed as follows when the amount of heat processed by the heat source is defined as Q, the amount of energy used by the heat source (the amount of gas consumed by the heat source equipment 1 (as a primary energy equivalent value)) is defined as PW1 and the amount of energy used by the heat source auxiliary equipment (the amount of electricity consumed by the heat source equipment 1 and the primary pump 2 (as a primary energy equivalent value)) is defined as PW2:ζ(=ΣQ/(PW1+PW2).

However, the heat source overall efficiency ζ is, in the end, a metric for evaluating the amount of energy consumed by the heat source, and is not suitable as a metric for evaluating an air-conditioning system.

For example, in the air-conditioning system illustrated in FIG. 10 that is unable to perform outdoor-air cooling, when air-conditioning is performed during the winter or during spring/autumn, the heat source equipment (cooling heat source) 1 is started up under outdoor air conditions wherein it can operate efficiently, raising the heat source overall efficiency ζ for the entire year. In contrast, in the air-conditioning system illustrated in FIG. 11 that is capable of performing outdoor-air cooling, the often the heat source equipment (the cooling heat source) 1 will be stopped when performing air conditioning using outdoor-air cooling during the winter and during spring/autumn. Because of this, the outdoor-air cooling during the winter and during spring/autumn will not be taken into account in the heat source overall efficiency ζ throughout the year, causing the yearly heat source overall efficiency ζ to fall.

The result is that regardless of success in energy conservation on the part of the air-conditioning system that performs air-conditioning through outdoor air cooling, in the actual evaluation of the yearly heat source overall efficiency ζ, the evaluation will be that the air conditioning system wherein the outdoor air cooling is not performed is superior.

That is, with the heat source overall efficiency ζ, the evaluation metric itself assumes that the equipment is operating, and, if based on this evaluation, then the energy conservation strategies will be biased towards efficiency improvements on the equipment manufacturer side and improvements in the equipment operation, taking away from that which can be performed by the building owners or occupants who do not have expert knowledge regarding the equipment. Conversely, even if energy conservation is achieved through the building owners and occupants assertively shutting down the heat source equipment (the cooling heat source) and aggressively using outdoor-air cooling, the evaluation will be that the yearly heat source overall efficiency has gone down, which may become an impediment to the promotion of appropriate energy conservation activities.

FIG. 12 through FIG. 16 show the relationships between the amounts of heat processed by the air conditioner 12 (the amount of heat processed by the air conditioner) and the indoor load of the controlled room 9 in the air-conditioning system illustrated in FIG. 11. FIG. 12 is a diagram for explaining the relationship between the amount of heat processed by the air conditioner and the indoor load in the summer. FIG. 13 is a diagram for explaining the relationship between the amount of heat processed by the air conditioner and the indoor load when there are no outdoor-air cooling operations in the spring/autumn. FIG. 14 is a diagram for explaining the relationship between the amount of heat processed by the air conditioner and the indoor load when there are outdoor-air cooling operations and there is cooling using chilled water in the spring/autumn. FIG. 15 is a diagram for explaining the relationship between the amount of heat processed by the air conditioner and the indoor load when there are outdoor-air cooling operations and there is no cooling using chilled water in the spring/autumn. FIG. 16 is a diagram for explaining the relationship between the amount of heat processed by the air conditioner and the indoor load in the winter. Note that in FIG. 12 through FIG. 16, it is entropy that should actually be shown; however, for simplicity in the explanation, the absolute humidities for the outdoor air, supply air, and indoors are assumed to be constant, so it is temperature that is shown.

In the summertime, the amount of heat processed by the air conditioner is the sum of the indoor load and the outdoor air load (FIG. 12). In the spring/autumn, if there are no outdoor-air cooling operations, there is little heat cooled by the outside air, and thus the amount of heat processed by the air conditioner will be large relative to the case wherein there are outdoor-air cooling operations (FIG. 13). During the spring/autumn, if there are outdoor-air cooling operations and cooling water is used for cooling, then the amount of heat processed by the air conditioner will be the difference between the indoor load and the heat cooled by the outside air (FIG. 14). Comparing the case wherein there are no outdoor-air cooling operations (FIG. 13) and the case where there are outdoor-air cooling operations (FIG. 14) for the spring/autumn, if the outdoor-air cooling operations are implemented, then shutting off the return air and drawing in large amounts of cold outdoor makes it is possible to reduce the amount of heat processed by the air conditioner even with an identical indoor load. During the spring/autumn, the amount of heat processed by the air conditioner goes to zero if there are outdoor-air cooling operations and there is no cooling using cooling water (FIG. 15). In this case, the outdoor air temperature is adequately low, making it possible to process the indoor load through air conditioner damper control alone, without cooling using the coil. In the wintertime, the amount of heat processed by the air conditioner becomes the amount of heating heat in order to supplement the amount by which the room becomes too cold due to the low outdoor temperature. Note that in FIG. 13 through FIG. 16, the indoor load is reduced below that in the state in FIG. 12 due to the flow of heat passing from the inside to the outdoor of the controlled room 9.

In this way, even if the indoor load remains the same, the amount of heat processed by the air conditioner will vary depending on the outdoor-air cooling operations. While in this example outdoor-air cooling operations are performed as an energy conserving method in order to reduce the amount of heat processed by the air conditioner, the amount of heat processed by the air conditioner will also vary depending on environmental load reduction operations (CO₂ control (operations to control the amount introduced into the environment at peak times)) or when performing energy conservation measures such as installing total heat exchanging equipment. Because the heat source overall efficiency ζ does not take into consideration the amount of heat processed by the air conditioner, which changes depending on these energy conservation activities, that is, because it does not take into account the amount of heat processed by the air conditioner, which is reduced by these energy conservation activities, it cannot evaluate accurately the energy efficiency in the air-conditioning system. Consequently, the heat source overall efficiency ζ is not appropriate as a metric for evaluating an air-conditioning system.

The present invention is to solve the problems such as set forth above, and the object thereof is to provide a device and method for calculating the overall efficiency of an air-conditioning system, able to evaluate accurately the energy efficiency of the air-conditioning system.

### SUMMARY OF THE INVENTION

The present invention, in order to achieve the object set forth above, calculates an indoor load for the controlled room from, at least, the indoor temperature of the controlled room, the temperature of the conditioned air that is supplied to be controlled room, and the amount of the conditioned air that is supplied to the controlled room, and calculates the overall efficiency of the air-conditioning system based on the calculated indoor load and the sum of the amount of energy used in the heat source equipment, the heat source auxiliary equipment, and the air conditioner.

Given the present invention, the indoor load, which is not affected by whether or not there are energy conservation measures, is calculated, and the overall efficiency of the air-conditioning system is calculated based on the calculated indoor load and on the total value for the amount of energy used by the heat source equipment, the heat source auxiliary equipment, and the air conditioner. For example, the indoor load is calculated from the indoor entropy of the controlled room, the supply air entropy of the conditioned air that is supplied into the controlled room, and the amount of the conditioned air that is supplied into the controlled room, and the overall efficiency of the air-conditioning system is calculated based on the calculated indoor load and the total value for the amount of energy used by the heat source equipment, the heat source auxiliary equipment, and the air conditioner.

In the present invention, if the indoor load is calculated from the indoor entropy of the controlled room, the supply air entropy of the conditioned air that is supplied into the controlled room, and the amount of conditioned air that is supplied into the controlled room, then, for example, the indoor entropy would be calculated from the indoor temperature and the indoor humidity in the controlled room, and the supply air entropy would be calculated from the temperature and humidity of the conditioned air that is supplied to the controlled room. Note that if it is difficult to calculate the entropy, then the indoor temperature of the controlled room may be used as a proxy for the indoor entropy, and the temperature of the conditioned air that is supplied to the controlled room may be used as a proxy for the supply air entropy. Moreover, the amount of conditioned air that is supplied into the controlled room need not necessarily be a measured value, but rather may use a value calculated through an equation, such as the rated airflow of the air conditioner×the INV power (%).

Additionally, when, within the air conditioning system, there is a plurality of heat source equipment, heat source supplementary equipment, air conditioners, and controlled rooms, then a total value for the indoor loads within the air-conditioning system may be calculated by summing the indoor load for each of the controlled rooms, and the overall efficiency of the air conditioning system can be calculated based on the calculated total value for the indoor loads and the total value for the amount of energy used by the heat source equipment, the heat source supplementary equipment, and the air conditioners. Moreover, if the heat source equipment runs on gas, then the amount of gas consumed, used by the heat source equipment (the primary energy equivalent value thereof) may be used for the amount of energy used by the heat source equipment, and the amount of electricity consumed, used by the heat source equipment (the primary energy equivalent value thereof) may be included in the amount of energy used by the heat source auxiliary equipment, or the amount of gas consumed, used by the heat source equipment (the primary energy equivalent value thereof) and the amount of electricity used (the primary energy equivalent value thereof) may be combined as the amount of energy used by the heat source equipment.

Additionally, in the present invention, the concept of an “air conditioner” includes, in addition to an FCU (fan coil unit) and outdoor air conditioning equipment, a stand-alone package-type air conditioner provided with a heat source, or the like. Moreover, in the present invention, the concepts of the indoor temperature and the indoor humidity include the temperature and humidity of the return air from the room, the temperature and humidity of the exhaust air from the room, and so forth.

In the present invention, the indoor load of the controlled room, which is not affected by whether or not there are energy conservation measures, is calculated, and the overall efficiency of the air-conditioning system is calculated based on the calculated indoor load and the total value of the amount of energy used by the heat source equipment, the heat source auxiliary equipment, and the air conditioner, thus enabling the amount of heat processed by the air conditioner, which has been reduced by the energy conservation measures, to be taken into account, thereby enabling the energy conservation measures in the air conditioning system to be evaluated accurately.

### BRIEF DESCRIPTION OF THE DRAWINGS

FIG. 1 is an instrumentation diagram illustrating a form of embodiment of an air-conditioning system that uses an air-conditioning system overall efficiency calculating device according to the present invention.

FIG. 2 is a flowchart illustrating the calculating process for the daily indoor load in the overall efficiency calculating device in this air-conditioning system.

FIG. 3 is a flowchart illustrating the calculating process for the daily total values for the amount of energy used in the overall efficiency calculating device in this air-conditioning system.

FIG. 4 is a flowchart illustrating the calculating process for the overall efficiency in the overall efficiency calculating device in this air-conditioning system.

FIG. 5 is a functional block diagram of the overall efficiency calculating device in this air-conditioning system.

FIG. 6 is a diagram illustrating the changes in the overall efficiency of the air-conditioning system by month, together with the changes in the indoor loads, the primary energy consumption, and the amount of heat in the load.

FIG. 7 is an instrumentation diagram illustrating a first modified example of the air-conditioning system.

FIG. 8 is an instrumentation diagram illustrating a second modified example of the air-conditioning system.

FIG. 9 is an instrumentation diagram illustrating a third modified example of the air-conditioning system.

FIG. 10 is an instrumentation diagram illustrating an air conditioning system incapable of performing outdoor air cooling, as one example of a conventional air-conditioning system.

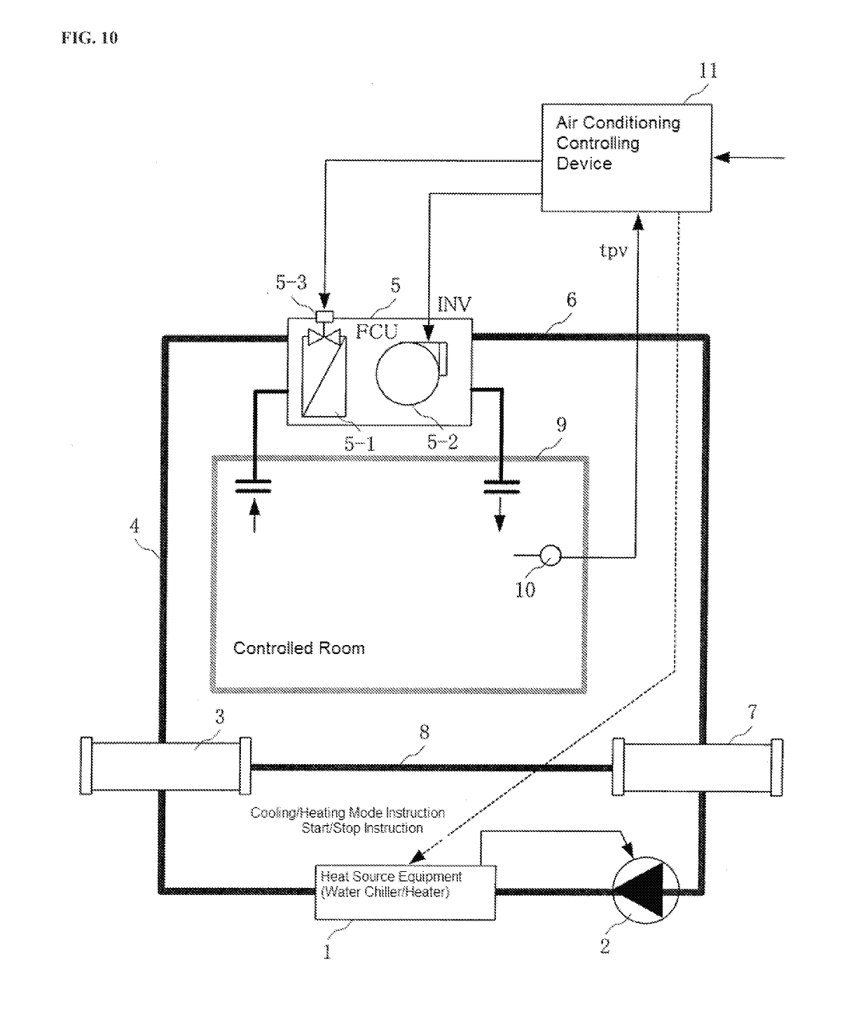

FIG. 11 is an instrumentation diagram illustrating an air conditioning system capable of performing outdoor air cooling, as one example of a conventional air-conditioning system.

FIG. 12 is a diagram for explaining the relationship between the amount of heat processed by the air conditioner and the indoor load in the summer.

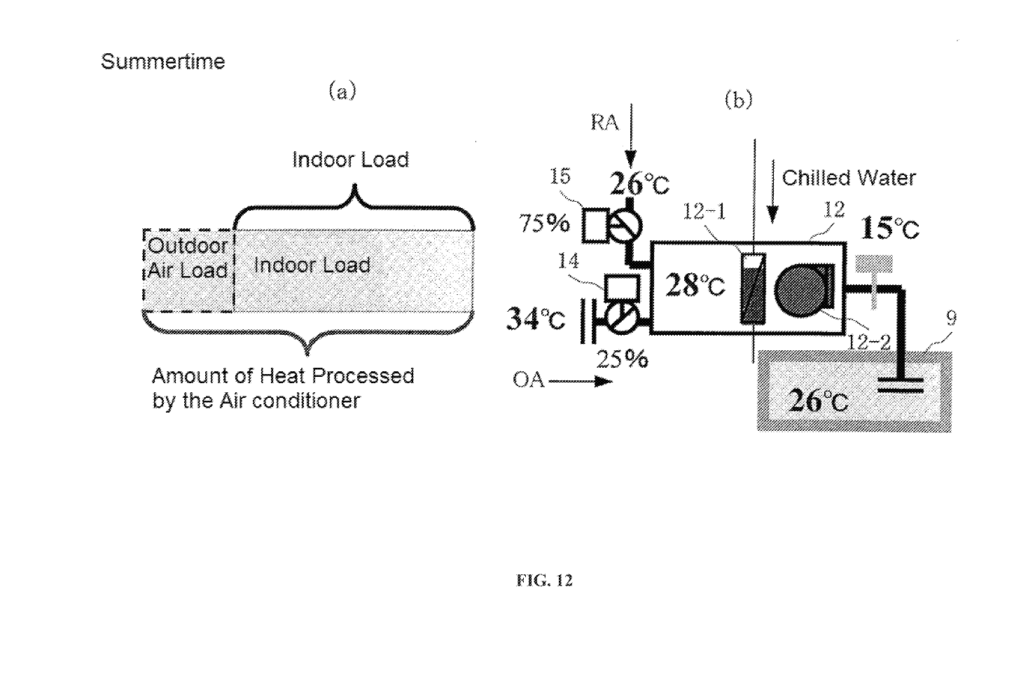

FIG. 13 is a diagram for explaining the relationship between the amount of heat processed by the air conditioner and the indoor load when there are no outdoor air cooling operations in the spring/autumn.

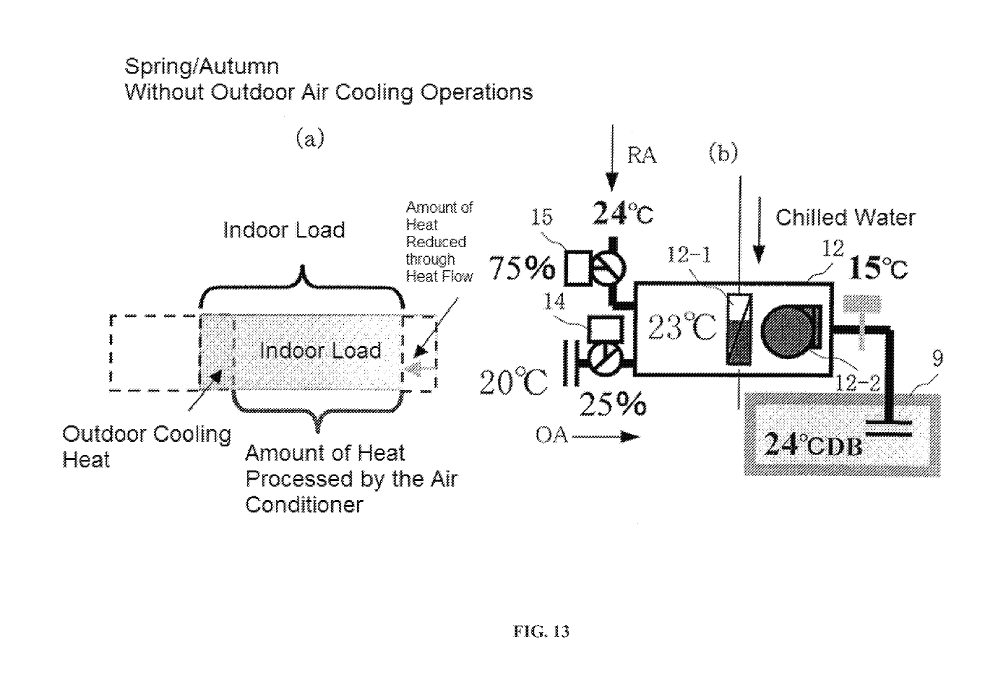

FIG. 14 is a diagram for explaining the relationship between the amount of heat processed by the air conditioner and the indoor load when there are outdoor air cooling operations and there is cooling using chilled water in the spring/autumn.

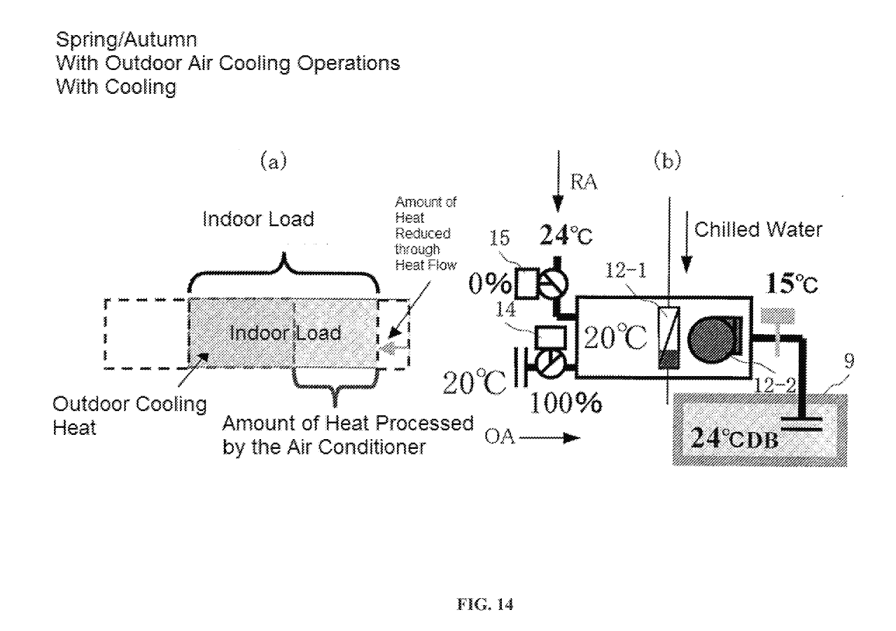

FIG. 15 is a diagram for explaining the relationship between the amount of heat processed by the air conditioner and the indoor load when there are outdoor air cooling operations and there is no cooling using chilled water in the spring/autumn.

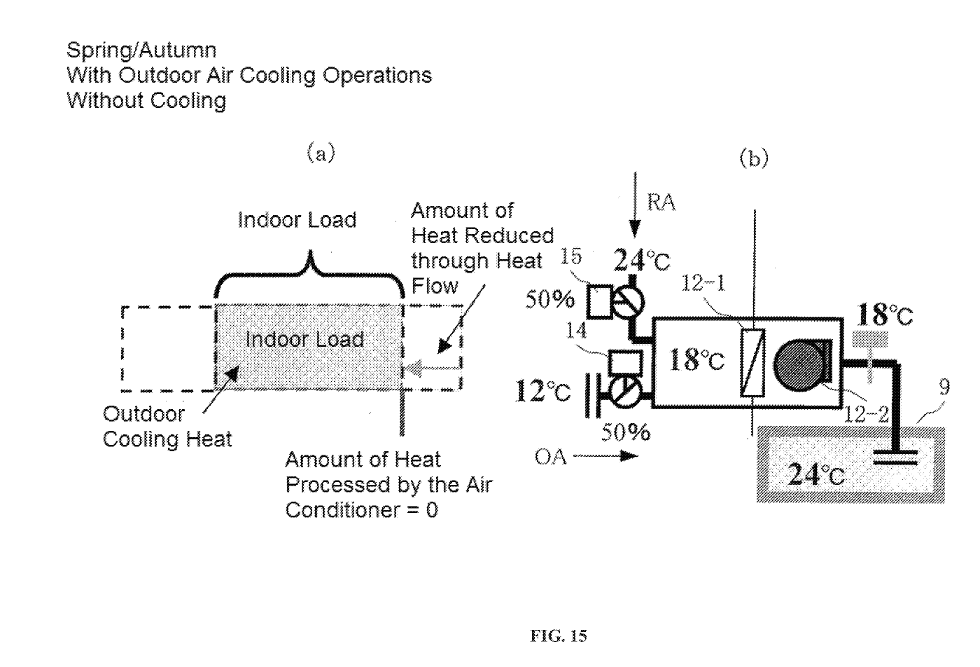

FIG. 16 is a diagram for explaining the relationship between the amount of heat processed by the air conditioner and the indoor load in the winter.

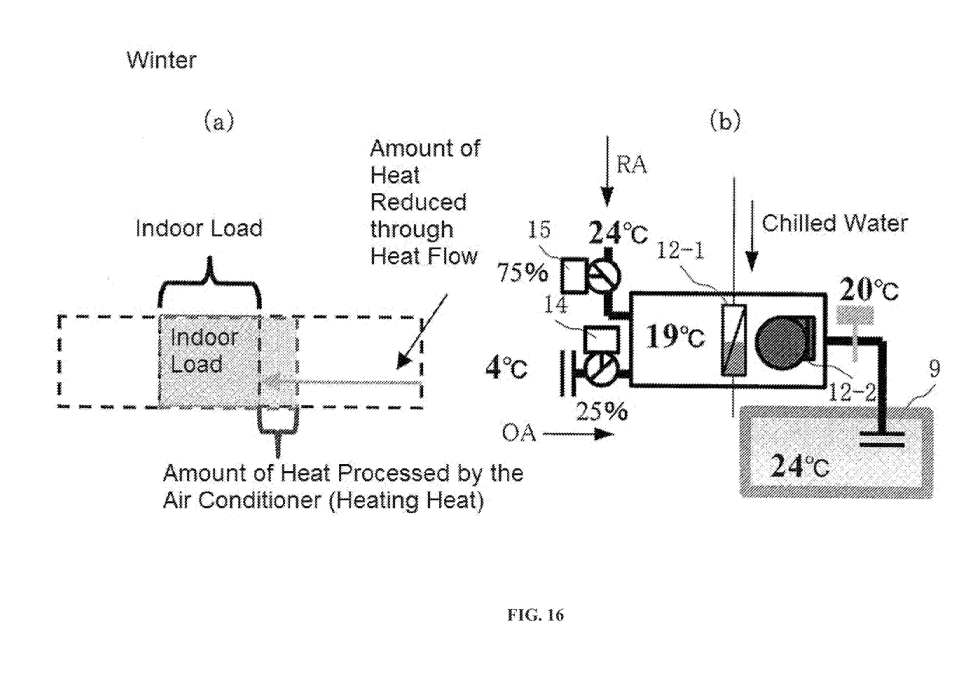

### DETAILED DESCRIPTION OF THE INVENTION

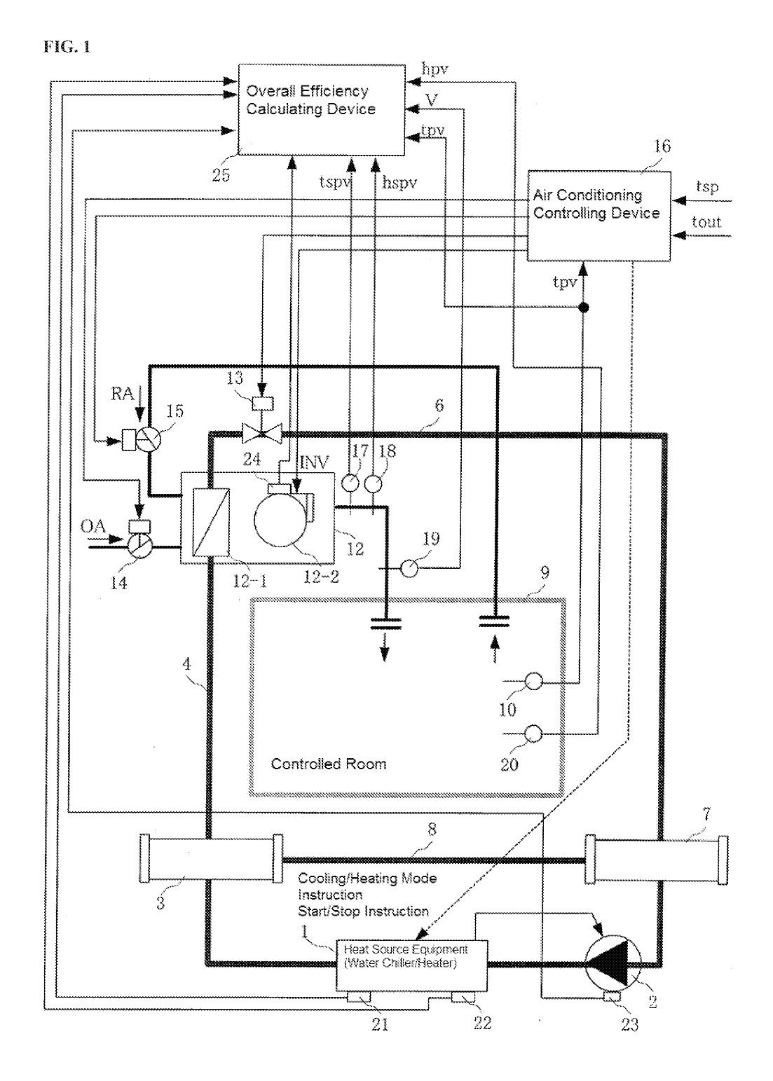

An example of the present invention is explained below in detail, based on the drawings. FIG. 1 is an instrumentation diagram illustrating an example of an air-conditioning system that uses an air-conditioning system overall efficiency calculating device according to the present invention.

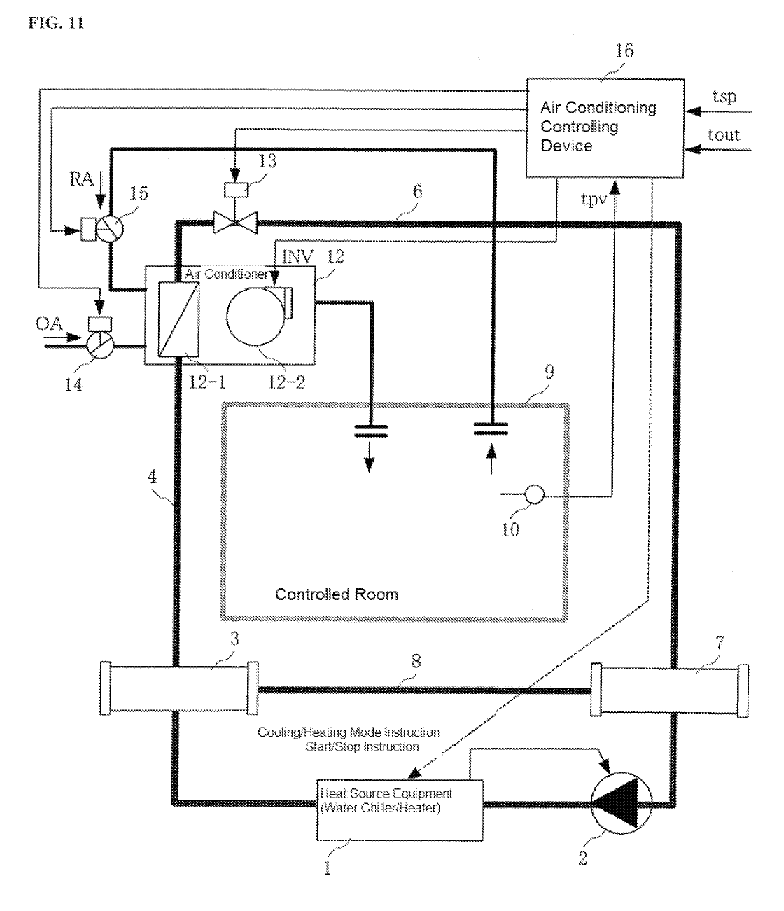

In this figure, codes that are the same as those in FIG. 11 indicate identical or equivalent structural elements as the structural elements explained in reference to FIG. 11, and explanations thereof are omitted.

In this air-conditioning system, a temperature sensor 17 and a humidity sensor 18, for measuring the temperature (the supply air temperature) and the humidity (the supply air humidity) of the conditioned air and an air flow sensor 19 for measuring the airflow of the conditioned air (the supply air flow rate) are provided in the supply path for the conditioned air from an air conditioner 12 to a controlled room 9. Additionally, a temperature sensor 10, for measuring the indoor temperature within the controlled room 9, and a humidity sensor 20, for measuring the indoor humidity within the controlled room 9, provided in the controlled room 9.

Additionally, a gas consumption meter 21, for measuring the amount of gas consumed by the heat source equipment 1, and an electric power meter 22, for measuring the amount of electricity consumed by the heat source equipment 1 are provided in the heat source equipment (the gas-driven heat source equipment) 1. Moreover, an electric power meter 23 for measuring the amount of electricity consumed by the primary pump 2 is provided in the primary pump 2, and an electric power meter 24 for measuring the amount of electricity consumed by the fan 12-2 is provided in the fan 12-2 of the air conditioner 12.

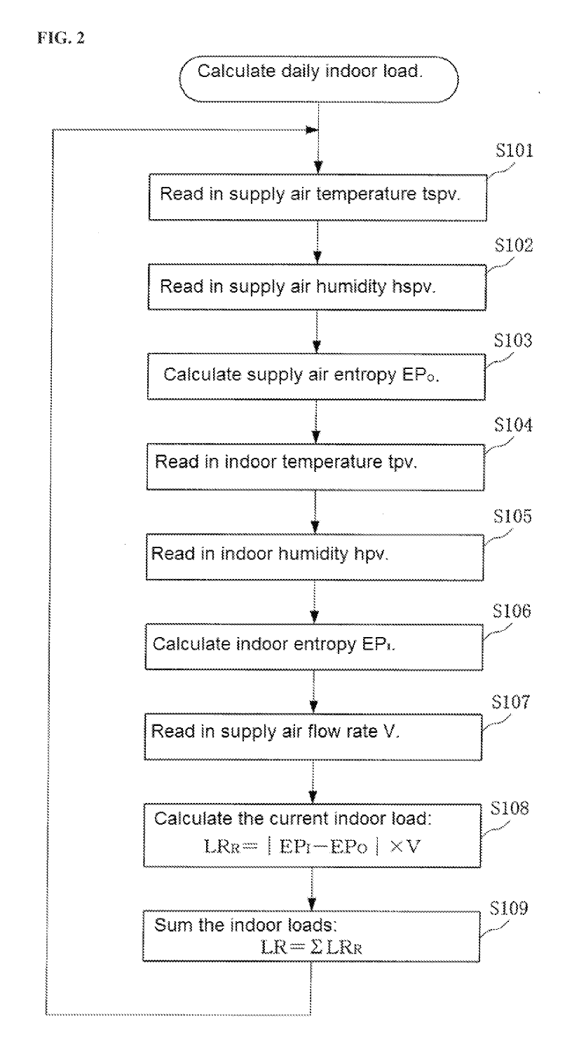

Additionally, an overall efficiency calculating device 25, as one example of the overall efficiency calculating device according to the present invention, is provided in the air-conditioning system. The overall efficiency calculating device 25 is embodied in hardware that includes a processor and a storage device, and a program that, in cooperation with this hardware, achieves various types of functions, having an overall efficiency calculating function as a function that is unique to the present form of embodiment. The overall efficiency calculating function of the overall efficiency calculating device 25 will be explained below following the flowcharts illustrated in FIG. 2 through FIG. 4.

### Calculating and Summing the Indoor Loads (FIG. 2)

The overall efficiency calculating device 25 reads in a measured value tspv for the supply air temperature from the temperature sensor 17 and a measured value hspv for the supply air humidity from the humidity sensor 18 (Step S101 and S102), and calculates the supply air entropy EP_{O} from the measured value tspv for the supply air temperature and the measured value hspv for the supply air humidity that have been read in (Step S103).

It then reads in a measured value tpv for the indoor temperature from the temperature sensor 10 and a measured value hpv for the indoor humidity from the humidity sensor 20 (Step S104 and S105), and calculates the indoor entropy EP_{I} from the measured value tpv for the indoor temperature and the measured value hpv for the indoor humidity that have been read in (Step S106).

Following this, the overall efficiency calculating device 25 reads in a rate of supply air flow V into the controlled room 9 from the air flow sensor 19 (Step S107) and uses Equation (2), below, to calculate the current indoor load LR_{R} from the rate of supply air flow V that has been read in, the supply air entropy EP_{O} calculated in Step S103, and the indoor entropy EP_{I} calculated in Step S106 (Step S108):

LR_{R}=|EP_{I}−EP_{O}|×V (2)

The overall efficiency calculating device 25 sums up the current loads LR_{R}, obtained in Step S108, while repeating the processes in Step S101 through S108 (Step S109), to calculate a daily indoor load LR (where LR=ΣLR_{R}).

Thereafter, the overall efficiency calculating device 25 repeats the processes in Step S101 through S109, in the same manner, to calculate the indoor load LR for each individual day, storing the results in memory.

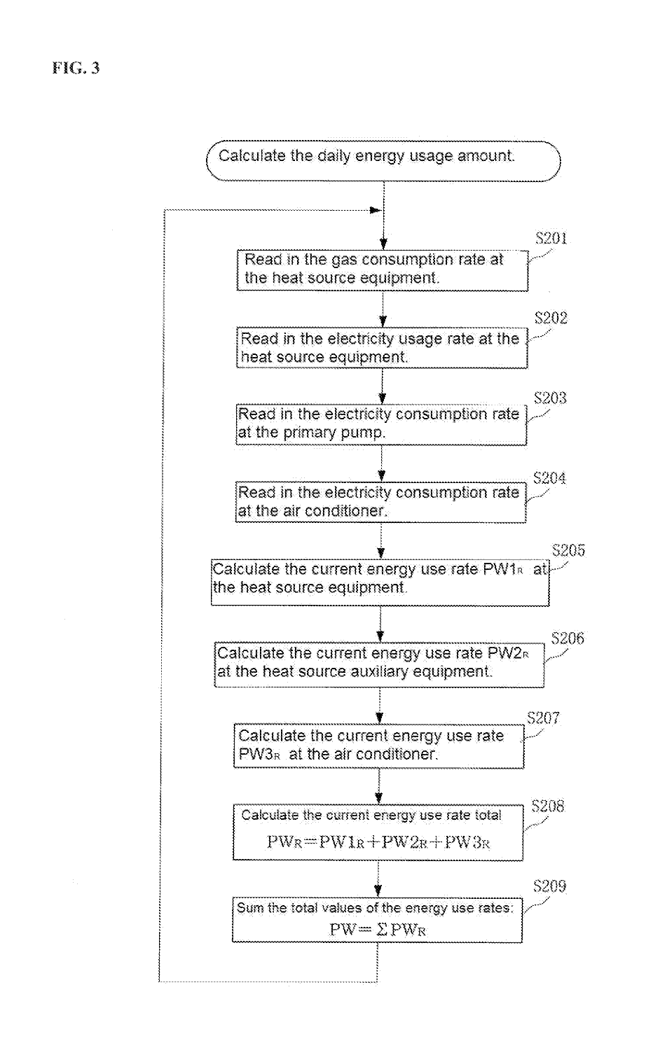

### Calculating and Summing the Total Values for the Amount of Energy Used (FIG. 3)

The overall efficiency calculating device 25 reads in the instantaneous value for the rate of gas consumption by the heat source equipment 1, measured by the gas consumption meter 21, the instantaneous value for the rate of electricity consumption by the heat source equipment 1, measured by the electric power meter 22, the instantaneous value for the rate of electricity consumption by the primary pump 2, measured by the electric power meter 23, and the instantaneous value for the rate of electricity consumption by the fan 12-2 in the air conditioner 12, measured by the electric power meter 23 (Step S201 through S204).

Following this, the rate of gas consumption by the heat source equipment 1, read in Step S201, is converted into a primary energy equivalent value, and this converted primary energy equivalent value is defined as the current rate of use of energy PW1_{R} of the heat source equipment (Step S205). Following this, the rate of electricity consumption by the heat source equipment 1, read in Step S201, is added to the rate of electricity consumption of the primary pump 2, ready and in Step S203, and is converted into a primary energy equivalent value, and this converted primary energy equivalent value is defined as the current rate of use of energy PW2_{R} of the heat source auxiliary equipment (Step S206). Moreover, the rate of electricity consumption by the fan 12-2 in the air conditioner 12, read in Step S204, is converted into a primary energy equivalent value, and this converted primary energy equivalent value is defined as the current rate of use of energy PW3_{R} of the air conditioner (Step S207).

Following this, the calculated rate of energy use PW in the heat source equipment, the rate of energy use PW2_{R} in the heat source auxiliary equipment, and the rate of energy use PW3_{R} in the air conditioner are added together, to calculate the total value PW_{R} (PW_{R}=PW1_{R}+PW2_{R}+PW3_{R}) for the current rate of energy use (Step S208).

The overall efficiency calculating device 25 sums up the current energy use rates PW_{R}, obtained in Step S208, while repeating the processes in Step S201 through S208 (Step S209), to calculate a daily energy use amounts PW (where PW=ΣPW_{R}).

Thereafter, the overall efficiency calculating device 25 repeats the processes in Step S201 through S209, in the same manner, to calculate the energy usage amounts PW for each individual day, storing the results in memory.

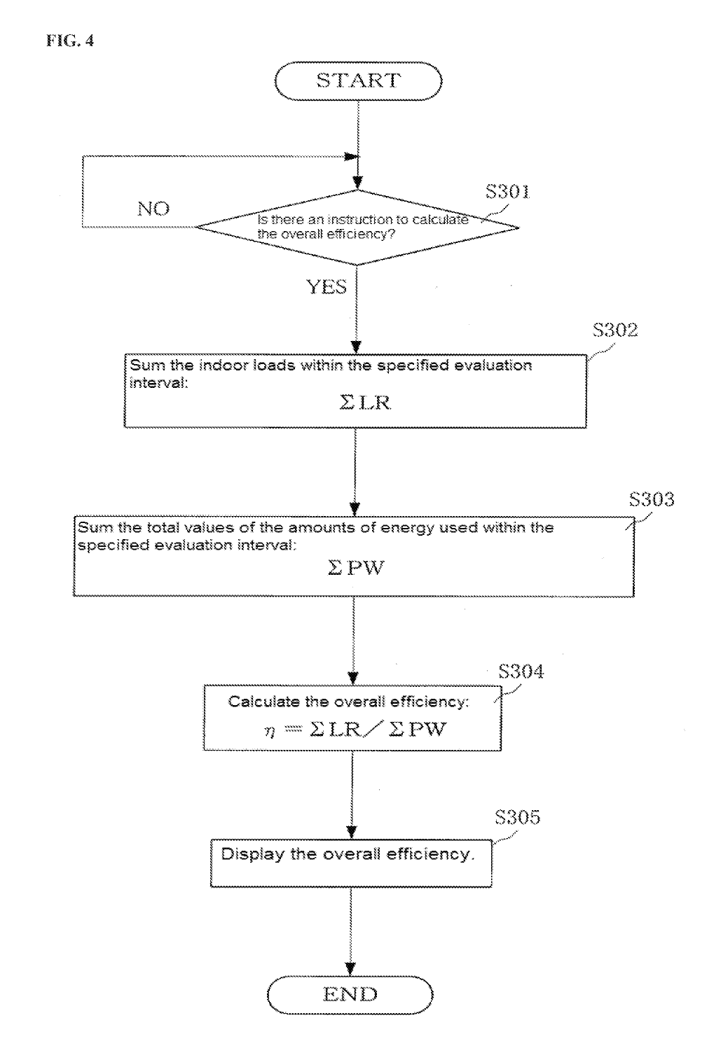

### Calculating the Overall Efficiency of the Air-Conditioning System (FIG. 4)

When an operator wishes to evaluate the energy efficiency of the air-conditioning system, the operator specifies an evaluation interval and issues, to the overall efficiency calculating device 25, an instruction for calculating the overall efficiency. For example, if one wishes to evaluate the energy efficiency of the air-conditioning system over a year's time, one would specify the evaluation interval as one year, and issue an instruction to the overall efficiency calculating device 35 to calculate the overall efficiency. In this case, the evaluation interval is one year.

When the evaluation interval has been specified and the overall efficiency calculating device 25 has been issued an instruction to calculate the overall efficiency (Step S301: YES), it sums up the indoor loads LR for each day within the specified evaluation interval (Step S302). It then sums up the total values PW for the amounts of energy consumed each day in the specified evaluation interval (Step S303).

Following this, the summation value (ΣLR) of the indoor loads LR for each day within the evaluation interval (calculated in Step S302) is divided by the summation value (ΣPW) of the total values PW of the amounts of energy consumed each day in the evaluation interval (calculated in Step S303), to calculate the overall efficiency η (where η=ΣLR/ΣW) of the air-conditioning system during the evaluation interval (Step S304). The calculated overall efficiency η for the air-conditioning system over the evaluation interval is displayed on a display (Step S305).

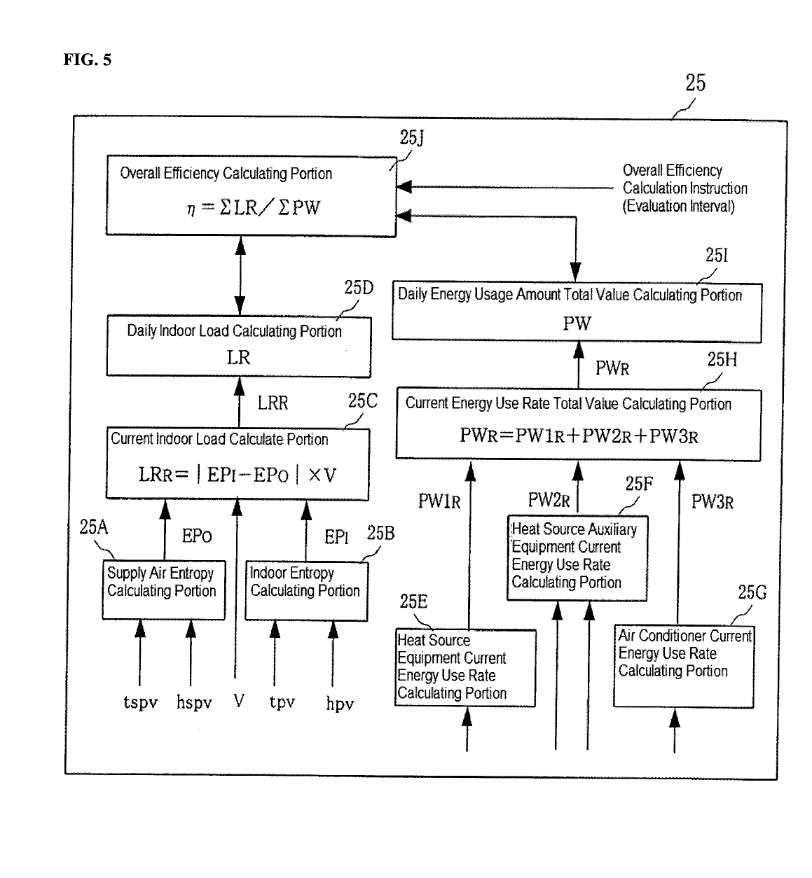

FIG. 5 shows a functional block diagram of the overall efficiency calculating device 25 that performs the processing operations described above. In the figure: 25A is a supply air entropy calculating portion; 25B is an indoor entropy calculating portion; 25C is a current indoor load calculating portion; 25D is a daily indoor load summing portion; 25E is a heat source equipment current energy use rate calculating portion; 25F is a heat source auxiliary equipment current energy use rate calculating portion; 25G is an air conditioner current energy use rate calculating portion; 25H is a current energy use rate total value calculating portion; 25I is a daily energy usage amount total value calculating portion; and 25J is an overall efficiency calculating portion

In this functional block diagram, the supply air entropy calculating portion 25A calculates the supply air entropy EP_{O} from the supply air temperature measured value tspv and the supply air humidity measured value hspv. The indoor entropy calculating portion 25B calculates the indoor entropy EP_{I} from the indoor temperature measured value tpv and the indoor humidity measured value hpv. The current indoor load calculating portion 25C inputs the supply air entropy EP_{O} from the supply air entropy calculating portion 25A, the indoor entropy EP_{I} from the indoor entropy calculating portion 25B, and the rate of supply air flow V into the controlled room 9, to calculate the current indoor load LR_{R} as LR_{R}=|EP_{I}−EP_{O}|×V. The daily indoor load summing portion 25D sums up the current indoor loads LR_{R}, calculated by the current indoor load calculating portion 25C, to calculate the daily indoor load LR.

The heat source equipment current energy use rate calculating portion 25E converts the gas consumption rate at the heat source equipment 1 into a primary energy equivalent value, as the current energy use rate PW1_{R} of the heat source equipment. The heat source auxiliary equipment current energy use rate calculating portion 25F converts the electricity consumption rate at the heat source equipment 1 and the electricity consumption rate at the primary pump 2 into a primary energy equivalent value, as the current energy use rate PW2_{R} of the heat source auxiliary equipment. The air conditioner current energy use rate calculating portion 25G converts the electricity consumption rate at the fan 12-2 into a primary energy equivalent value, as the current energy use rate PW3_{R} of the air conditioner. The current energy use rate total value calculating portion 25H adds together the heat source equipment energy use rate PW1_{R}, the heat source auxiliary equipment energy use rate PW2_{R}, and the air conditioner energy use rate PW3_{R}, to calculate the current energy use rate total value PW_{R}. The daily energy usage amount total value calculating portion 25I sums up the current energy use rate total values PW_{R}, calculated by the current energy use rate total value calculating portion 25H, to calculate the daily energy usage amount total value PW.

The overall efficiency calculating portion 25J, when the evaluation interval is specified and an overall efficiency calculating instruction is applied, obtains, from the daily indoor load summing portion 25D, the daily indoor loads LR within the specified evaluation interval, and obtains, from the daily energy usage rate total value calculating portion 25I, the daily energy usage amount total values PW within the specified evaluation interval, to calculate the air-conditioning system overall efficiency η During the evaluation interval as η=ΣLR/ΣPW.

Note that while in this example the ΣPW was calculated by summing, during the evaluation interval, the daily energy usage amount total values, calculated from instantaneous values, conversely the energy usage amount total value ΣPW for the evaluation interval may be calculated from energy measurement summation values.

This air-conditioning system overall efficiency η has the following distinctive features when compared to the conventional heat source overall efficiency ζ. The air-conditioning system overall efficiency η is obtained as η=Σ indoor loads/Σ(amounts of energy used by the heat source equipment+amounts of energy used by the heat source auxiliary equipment+amounts of energy used by the air conditioner). In this case, the amount of energy used by the air conditioner is added to the amount of energy used, thus calculating the efficiency of the air-conditioning system as a whole. Moreover, the calculation uses “indoor load” rather than the “amount of heat processed by the heat source,” thus enabling an accurate evaluation of the energy efficiency of the air-conditioning system, taking into account the amount of heat processed by the air conditioner, which are reduced by the outdoor-air cooling operations.

That is, when calculating the overall efficiency η of the air-conditioning system, using “amount of energy used” in the denominator and “amount of air conditioning that has been performed” in the numerator makes it possible to perform the evaluation taking into account the outdoor-air cooling operations (the energy conservation operations). Note that the air-conditioning system energy conservation operations can be evaluated accurately not just for outdoor-air cooling operations, but also for environmental load reducing operations (CO₂ control (control to limit the amount introduced into the atmosphere at peak times)), and energy conservation measures performed through the installation of total heat exchange equipment.

In an air-conditioning system, the value for the indoor load does not change even in systems wherein the outdoor air can change, such as outdoor-air cooling and CO₂ control, and thus the value of “amount of air conditioning that has been performed” is convenient. In the present example, the indoor load is calculated from the supply air temperature, the supply air humidity, the indoor temperature, the indoor humidity, and the supply air flow rate, as |indoor entropy−supply air entropy|×supply air flow rate. Note, the amount of the air supplied need not necessarily be a measured value, but rather may use a value calculated through an equation, such as the rated airflow of the air conditioner 12 (the rated airflow of the fan 12-2)×the INV power (%).

Moreover, if it is difficult to calculate the entropy, then the indoor temperature of the controlled room may be used as a proxy for the indoor entropy, and the temperature of the conditioned air that is supplied to the controlled room (the supply air temperature) may be used as a proxy for the supply air entropy. That is, the temperature difference between the indoor temperature and the supply air temperature may be used as a proxy for the entropy difference, and the indoor load may be calculated from this entropy difference that is proxied by the temperature difference. In typical offices, and the like, there are few sources that produce moisture within the room, and thus there are many buildings wherein using the temperature difference as the proxy will not be a problem.

In the present example, as described above, calculating the overall efficiency η from the indoor load as the air-conditioning system evaluating metric reflects the energy conservation efforts of the administrators and occupants in turning off equipment and assertively using outdoor-air cooling, thus making it possible for the owner and administrators to confirm the results of energy conservation efforts, making it possible to promote the desire to conserve energy on behalf of the administrators and occupants. For example, in an air-conditioning system wherein the switching of the outdoor-air cooling can be performed through a user interface, assertive priority by the occupants (their efforts and diligence) in the use of outdoor-air cooling is not reflected in the heat source overall efficiency ζ, but is reflected in the air-conditioning system overall efficiency η, and thus this evaluation is appropriate.

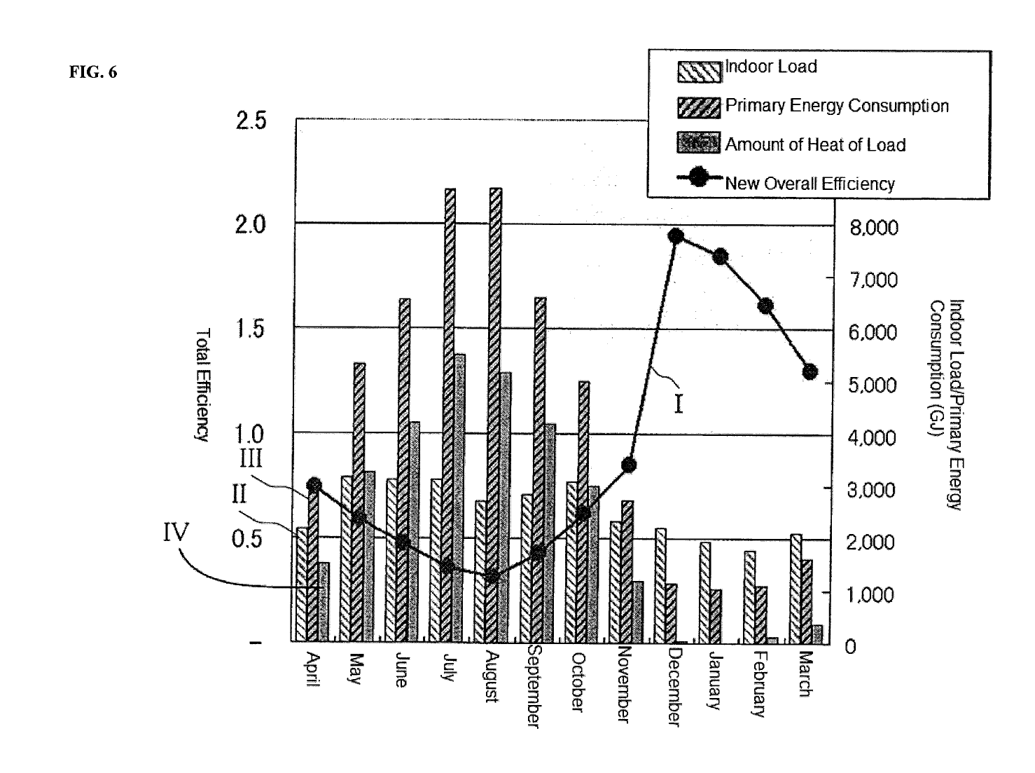

FIG. 6 illustrates an example of the changes in the air-conditioning system overall efficiency η by month. In this figure, the changes in the overall efficiency η by month are indicated by the line graph I. Note that, for reference, the bar graph II shows the indoor load, the bar graph III shows the primary energy consumption (the total value for the amount of energy used), and the bar graph IV shows amount of heat for the load, for each month. The overall efficiency η falls in the summertime when the outdoor air load must be processed, but, conversely, rises in the springtime when it is possible to reduce the amount of heat processed by the air conditioner using the outdoor air. In FIG. 6, the overall efficiency η rises substantially in December through March wherein the heat source equipment is stopped and only the air conditioner is run.

### An Alternative Example of the Air-Conditioning System

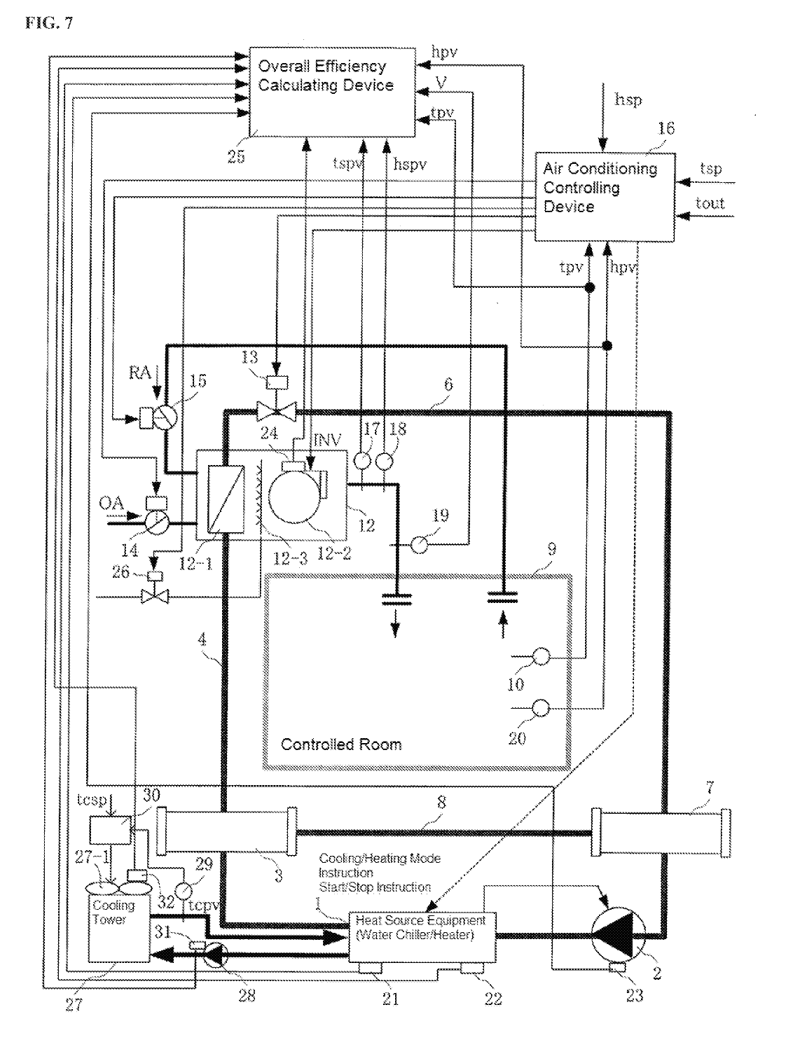

FIG. 1 showed a simple example of an air-conditioning system. FIG. 7 shows an alternative example (alternative example 1) of the air-conditioning system illustrated in FIG. 1. In the first alternative example of the air-conditioning system, a humidifier 12-3 is provided in the air conditioner 12, and moisture is provided to the humidifier 12-3 through a humidifying valve 26. An air conditioning controlling device 16 inputs an indoor humidity measured value hpv for the controlled room 9 from a humidity sensor 20 and controls the amount of moisture to the humidifier 12-3 through the humidifying valve 26 so that the indoor humidity measured value hpv will match an indoor humidity setting value hsp.

Additionally, in the air-conditioning system, a cooling tower 27 is provided for the heat source equipment 1, where chilled water that is produced by the cooling tower 27 is provided by a chilled water pump 28 to the heat source equipment 1. A cooling fan 27-1 is provided in the cooling tower 27, and the speed of rotation of the cooling fan 27-1 is controlled by a controller 30 so that the temperature tcpv of the chilled water to the heat source equipment 1, measured by a temperature sensor 29, goes to a setting temperature tcsp. Moreover, when the heat source equipment 1 is started up as a cooling/heating source, the cooling water pump 28 is started up in coordination therewith.

In the air-conditioning system, the overall efficiency calculating device calculates the overall efficiency η as η=Σ indoor load/Σ(amount of energy used by the heat source equipment+amount of energy used by the heat source auxiliary equipment+amount of energy used by the air conditioner); however, for the amount of energy used by the heat source auxiliary equipment, the amount of electricity used by the chilled water pump 28, measured by the electric power meter 31 (the primary energy equivalent value thereof) is added to the amount of electricity used by the cooling fan 27-1, measured by the electric power meter 32 (the primary energy equivalent value thereof).

### Another Alternative Example of the Air-Conditioning System

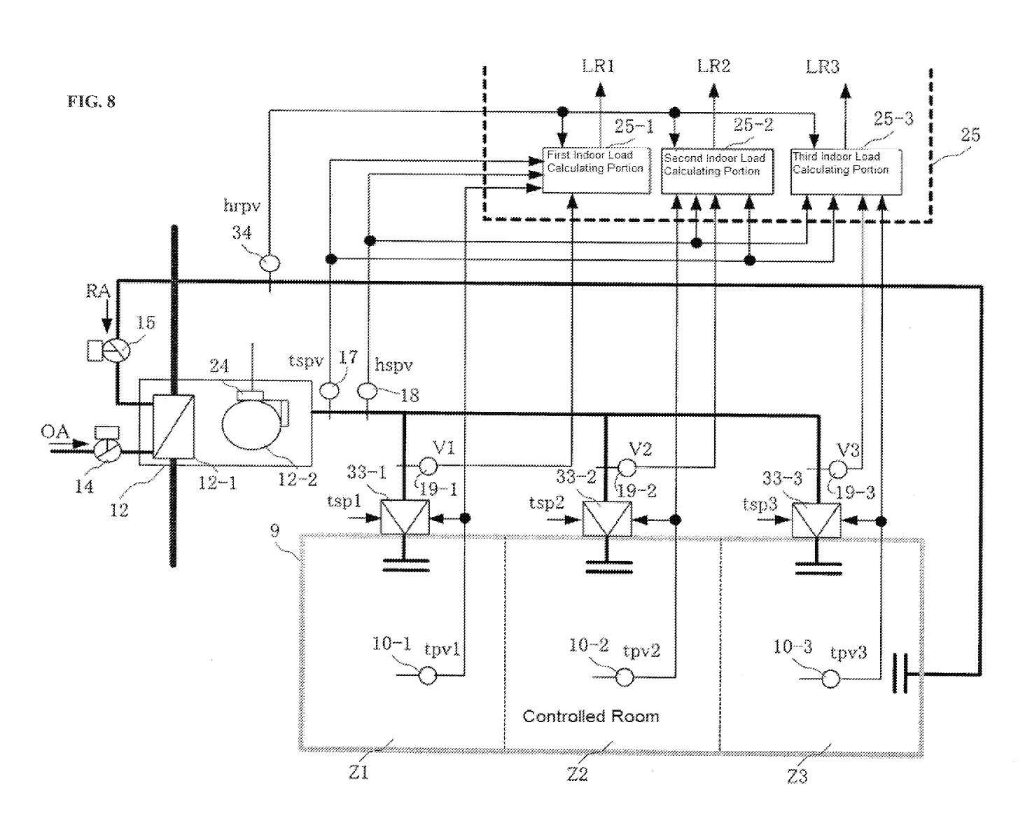

FIG. 8 shows an example wherein a plurality of variable air flow rate adjusting valves (VAVs) is provided in the controlled room 9. In the present example, VAVs 33-1 through 33-3 are provided in the controlled room 9, where conditioned air is provided into zone Z1 on the left side of the controlled room 9 through the VAV 33-1, conditioned air is provided into zone Z2 in the middle of the controlled room 9 through the VAV 33-2, and conditioned air is provided into zone Z3 on the right side of the controlled room 9 through the VAV 33-3.

In this air-conditioning system, a temperature sensor 10-1 is provided in the zone Z1, and the amount of the conditioned air supplied (the supply air flow rate) to zone Z1 is controlled by the VAV 33-1 so that the indoor temperature tpv1 in zone Z1, measured by the temperature sensor 10-1, will match a setting temperature tsp1. A temperature sensor 10-2 is provided in the zone Z2, and the amount of the conditioned air supplied (the supply air flow rate) to zone Z2 is controlled by the VAV 33-2 so that the indoor temperature tpv2 in zone Z2, measured by the temperature sensor 10-2, will match a setting temperature tsp2. A temperature sensor 10-3 is provided in the zone Z3, and the amount of the conditioned air supplied (the supply air flow rate) to zone Z3 is controlled by the VAV 33-3 so that the indoor temperature tpv3 in zone Z3, measured by the temperature sensor 10-3, will match a setting temperature tsp3.

Additionally, in the air-conditioning set system, the conditioned air supply ducts to zones Z1, Z2, and Z3 are provided with air flow rate sensors 19-1, 19-2, and 19-3, for measuring individually, as supply air flow rates V1, V2, and V3, the amounts of conditioned air supplied to zones Z1, Z2, and Z3. Additionally, the return air duct from the controlled room 9 to the air conditioner 12 is provided with a humidity sensor 34 for measuring the humidity (return air humidity) of the return air RA from the controlled room 9.

In the air-conditioning system, the overall efficiency calculating device calculates the overall efficiency η as η=Σ indoor load/Σ(amount of energy used by the heat source equipment+amount of energy used by the heat source auxiliary equipment+amount of energy used by the air conditioner); however, the indoor load at this time is defined as the value wherein the indoor load LR1 of the zone Z1, to which the VAV 33-1 is assigned, the indoor load LR2 of the zone Z2, to which the VAV 33-2 is assigned, and the indoor load LR3 of the zone Z3, to which the VAV 33-3 is assigned, are added together.

### Calculating the Indoor Load LR1

In the overall efficiency calculating device 25, the calculation of the indoor load LR1 for zone Z1, which is the area to which VAV 33-1 is assigned, is performed in a first indoor load calculating portion 25-1. In this case, the first indoor load calculating portion 25-1 reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tpv1 for the indoor temperature is read in from the temperature sensor 10-1 and the measured value hrpv for the return air humidity is read in from the humidity sensor 34, and the indoor entropy EP1_{I} in the zone Z1 is calculated from the measured value tpv1 for the indoor temperature and the measured value hrpv for the return air humidity that have been read in. Following this, the supply air flow rate V1 into the zone Z1 is read in from the flow rate sensor 19-1, and the indoor load LR1 for the zone Z1 is calculated as LR1=|EP1_{I}−EP_{O}|×V1.

### Calculating the Indoor Load LR2

In the overall efficiency calculating device 25, the calculation of the indoor load LR2 for zone Z2, which is the area to which VAV 33-2 is assigned, is performed in a second indoor load calculating portion 25-2. In this case, the second indoor load calculating portion 25-2 reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tpv2 for the indoor temperature is read in from the temperature sensor 10-2 and the measured value hrpv for the return air humidity is read in from the humidity sensor 34, and the indoor entropy EP2_{I} in the zone Z2 is calculated from the measured value tpv2 for the indoor temperature and the measured value hrpv for the return air humidity that have been read in. Following this, the supply air flow rate V2 into the zone Z2 is read in from the flow rate sensor 19-2, and the indoor load LR2 for the zone Z2 is calculated as LR2=|EP2_{I}−EP_{O}|×V2.

### Calculating the Indoor Load LR3

In the overall efficiency calculating device 25, the calculation of the indoor load LR3 for zone Z3, which is the area to which VAV 33-3 is assigned, is performed in a third indoor load calculating portion 25-3. In this case, the third indoor load calculating portion 25-3 reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tpv3 for the indoor temperature is read in from the temperature sensor 10-3 and the measured value hrpv for the return air humidity is read in from the humidity sensor 34, and the indoor entropy EP3_{I} in the zone Z3 is calculated from the measured value tpv3 for the indoor temperature and the measured value hrpv for the return air humidity that have been read in. Following this, the supply air flow rate V3 into the zone Z3 is read in from the flow rate sensor 19-3, and the indoor load LR3 for the zone Z3 is calculated as LR3=|EP3_{I}−EP_{O}|×V3.

### A Further Alternative Example of the Air-Conditioning System

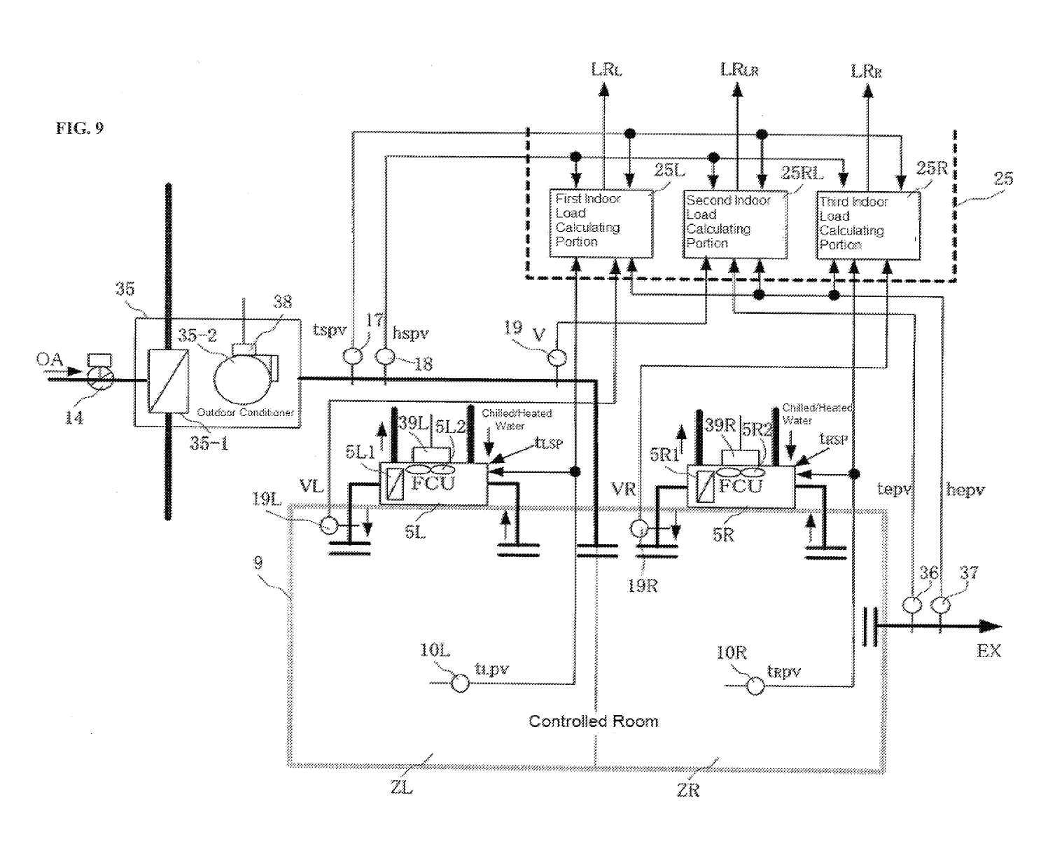

FIG. 9 shows an example wherein a plurality of air conditioners is provided for the controlled room 9. In this example, FCU 5L and FCU 5R and outdoor conditioner 35 are provided as air conditioners for the controlled room 9. An FCU 5L is provided for a zone ZL on the left side of the controlled room 9, and an FCU 5R is provided for a zone ZR on the right side of the controlled room 9. The outdoor conditioner 35 is provided for the entirety of the controlled room 9.

In this air-conditioning system, an air temperature sensor 10L is provided in the zone ZL, and the temperature and air flow rate (supply air flow rate) of the conditioned air into the zone ZL from the FCU 5L are controlled so that the indoor temperature tLpv within the zone ZL, measured by the temperature sensor 10L, will match the setting temperature tLsp. An air temperature sensor 10R is provided in the zone ZR, and the temperature and air flow rate (supply air flow rate) of the conditioned air into the zone ZR from the FCU 5R are controlled so that the indoor temperature tRpv within the zone ZR, measured by the temperature sensor 10R, will match the setting temperature tRsp.

Additionally, in this air-conditioning system, air flow rate sensors 19L and 19R for measuring, individually, as the supply air flow rates VL and VR, the rates of supply of the conditioned air into zones ZL and ZR are provided in the supply air ducts for the conditioned air into the zones VL and ZR. In addition, a temperature sensor 17 and a temperature sensor 18, for measuring the temperature and humidity of the conditioned air into the controlled room 9, and an air flow rate sensor 19, for measuring, as the supply air flow rate V, the air flow rate of the conditioned air, are provided in the supply air duct for the conditioned air from the outdoor conditioner 35 to the controlled room 9. Furthermore, a temperature sensor 36 and a humidity sensor 37 for measuring the temperature (exhaust air temperature) and humidity (exhaust air humidity) of the exhaust air EX that is exhausted from the controlled room 9 are provided in the exhaust air duct from the controlled room 9.

Note that the outdoor conditioner 35 is provided with a water chilling/heating coil 35-1 and a fan 35-2, where outdoor air OA is drawn in through an outdoor air damper 14, to adjust the temperature of the outdoor air that is supplied into the controlled room 9. In the present example, the outdoor air OA, wherein the temperature is adjusted by the outdoor conditioner 35, is also termed “conditioned air.”

Additionally, the outdoor conditioner is provided with an electric power meter 38 for measuring the amount of electricity consumed by a fan 35-2. Moreover, the FCUs 5L and 5R are provided with water chilling/heating coils 5L1 and 5R1, and fans 5L2 and 5R2, and provided with electric power meters 39L and 39R for measuring the amount of electricity consumed by the fans 5L2 and 5R2.

In the air-conditioning system, the overall efficiency calculating device calculates the overall efficiency η as η=Σ indoor load/Σ(amount of energy used by the heat source equipment+amount of energy used by the heat source auxiliary equipment+amount of energy used by the air conditioner); however, the indoor load at this time is defined as the value wherein the indoor load LR_{L} of the zone ZL, to which the FCU 5L is assigned, the indoor load LR_{R} of the zone ZR, to which the FCU 5R is assigned, and the indoor load LR_{LR} of the entire controlled room 9, to which the outdoor conditioner 35 is assigned, are added together.

### Calculating the Indoor Load LR_{L}

In the overall efficiency calculating device 25, the calculation of the indoor load LR_{L} for zone ZL, which is the area to which the FCU 5L is assigned, is performed in a first indoor load calculating portion 25L. In this case, the first indoor load calculating portion 25L reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tLpv for the indoor temperature is read in from the temperature sensor 10L and the measured value hepv for the exhaust air humidity is read in from the humidity sensor 37, and the indoor entropy EPL_{I} in the zone ZL is calculated from the measured value tLpv for the indoor temperature and the measured value hepv for the exhaust air humidity that have been read in. Following this, the supply air flow rate VL into the zone ZL is read in from the flow rate sensor 19L, and the indoor load LR_{L} for the zone ZL is calculated as LR_{L}=EPL_{I}−EP_{O}|×VL.

### Calculating the Indoor Load LR_{R}

In the overall efficiency calculating device 25, the calculation of the indoor load LR_{R} for zone ZR, which is the area to which the FCU 5R is assigned, is performed in a second indoor load calculating portion 25R. In this case, the second indoor load calculating portion 25R reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tRpv for the indoor temperature is read in from the temperature sensor 10R and the measured value hepv for the exhaust air humidity is read in from the humidity sensor 37, and the indoor entropy EPR_{I} in the zone ZR is calculated from the measured value tRpv for the indoor temperature and the measured value hepv for the exhaust air humidity that have been read in. Following this, the supply air flow rate VR into the zone ZR is read in from the flow rate sensor 19R, and the indoor load LR_{R} for the zone ZR is calculated as LR_{R}=|EPR_{I}−EP_{O}|×VR.

### Calculating the Indoor Load LR_{LR}

In the overall efficiency calculating device 25, the calculation of the indoor load LR_{LR} for the entirety of the controlled room 9, which is the area to which the outside conditioner 35 is assigned, is performed in a third indoor load calculating portion 25LR. In this case, the third indoor load calculating portion 25LR reads in the measured value tspv for the supply air temperature from the temperature sensor 17 and the measured value hspv for the supply air humidity from the humidity sensor 18, and calculates the supply air entropy EP_{O} from the measured value tspv for the supply air temperature and the measured value hspv for the supply air humidity that have been read in. Additionally, the measured value tepv for the exhaust air is read in from the temperature sensor 36 and the measured value hepv for the exhaust air humidity is read in from the humidity sensor 37, and the indoor entropy EP_{I} in the entirety of the controlled room 9 is calculated from the measured value tepv for the exhaust air temperature and the measured value hepv for the exhaust air humidity that have been read in. Following this, the supply air flow rate V into the controlled room 9 is read in from the flow rate sensor 19, and the indoor load LR_{LR} for the entirety of the controlled room 9 is calculated as LR_{LR}=|EP_{I}−EP_{O}|×V.

Additionally, in the air-conditioning system, the overall efficiency calculating device calculates the overall efficiency η as η=Σ indoor load/Σ (amount of energy used by the heat source equipment+amount of energy used by the heat source auxiliary equipment+amount of energy used by the air conditioner); however, for the amount of energy used by the heat source auxiliary equipment, the amount of electricity used by the fan 35-2 of the outdoor conditioner 35, measured by the electric power meter 38 (the primary energy equivalent value thereof) is added to the amounts of electricity used by the fans 5L2 and 5R2 of the FCUs 5L and 5R, measured by the electric power meters 39L and 39R (the primary energy equivalent values thereof).

Note that in FIG. 9, a stand-alone package-type air conditioner that is provided with a heat source may be provided instead of the FCUs 5L and 5R that are provided with water chilling/heating coils. In an air-conditioning system that is provided with this type of package-type air conditioner, the amount of electricity used in the heat source for the package-type air conditioner may be added to the amount of energy used as the heat source equipment when calculating the overall efficiency 11.

Additionally, while, for ease in the explanation, the air conditioning systems in the examples set forth above were explained divided into the type illustrated in FIG. 1 and FIG. 7 (the A type), the type illustrated in FIG. 8 (the B type), and the type illustrated in FIG. 9 (the C type), in central air conditioning systems, and the like used in high-rise buildings, and the like, a variety of types, such as the A type, B type, and C type, is mixed together. This type of air conditioning system, in order to calculate the indoor load for the building as a whole, the indoor loads are calculated for all of the equipment on the load side, that is, each VAV, each air conditioner, each outdoor conditioner, each FCU, and the like, and summed together. Moreover, in actual air-conditioning systems, a plurality of heat source equipment is also provided, and when the amount of energy used by the heat source auxiliary equipment and air conditioners is calculated, similarly, the amounts of energy used by each of the heat source equipment are calculated and summed together.

Additionally, while, in the examples set forth above the amount of gas consumed, used in the heat source equipment 1 (the primary energy equivalent value thereof) was used as the amount of energy used by the heat source equipment 1, and the amount of energy consumed, used by the heat source equipment 1 (the primary energy equivalent value thereof), was included in the amount of energy used by the heat source auxiliary equipment, instead the amount of gas consumed, used by the heat source equipment 1 (the primary energy equivalent value thereof) and the amount of electricity used thereby (the primary energy equivalent value thereof) may be combined together and used as the amount of energy used by the heat source equipment 1. Moreover, while in the examples set forth above, gas-driven heat source equipment was used as the heat source equipment 1, electrically-driven heat source equipment may be used instead. When electrically-driven heat source equipment is used, the amount of electricity consumed, used by the heat source equipment (the primary energy equivalent value thereof) is used as the amount of energy used by the heat source equipment.

Additionally, while in the examples set forth above, the indoor load was calculated in the overall efficiency calculating device 25, instead the indoor load may be calculated by the air conditioning controlling device 16 and the calculated indoor load may be sent to the overall efficiency calculating device 25. In this case, the example may be one wherein a portion of the functions of the overall efficiency calculating device 25 are delegated to the air conditioning controlling device 16, and the overall efficiency calculating device according to the present invention may be structured from the overall efficiency calculating device 25 and the air conditioning controlling device 16.

The overall efficiency calculating device and method for an air-conditioning system according to the present invention can be used in a variety of air conditioning systems, such as central air conditioning systems, as an overall efficiency calculating device and method for an air-conditioning system in order to calculate the overall efficiency of the air-conditioning system from the indoor load.

1. An overall efficiency calculating device for an air conditioner for calculating an overall efficiency as an evaluation metric for an air-conditioning system, used in an air-conditioning system that comprises heat source equipment for producing chilled/heated water, heat source auxiliary equipment that is provided as auxiliary equipment for the heat source equipment, and an air conditioner for receiving a supply of chilled/heated water from the heat source equipment and for supplying conditioned air into a controlled room, comprising:
an indoor load calculator calculating an indoor load for the controlled room from, at least, an indoor temperature of the controlled room, a temperature of the conditioned air that is supplied to the controlled room, and a supply rate of the conditioned air that is supplied to the controlled room; and
an overall efficiency calculator calculating an overall efficiency for the air-conditioning system based on the indoor load that is calculated by the indoor load calculator, and the total value for the amount of energy used by the heat source equipment, the heat source auxiliary equipment, and the air conditioner.

2. The overall efficiency calculating device for an air-conditioning system as set forth in claim 1, wherein the indoor load calculator also calculates an indoor load for the controlled room from indoor entropy for the controlled room, supply air entropy of conditioned air that is supplied into the controlled room, and the amount of supply of the conditioned air supplied into the controlled room.

3. The overall efficiency calculating device for an air-conditioning system as set forth in claim 2, wherein the indoor load calculator also calculates the indoor entropy from the indoor temperature and indoor humidity of the controlled room and calculates the supply air entropy from the temperature and humidity of the conditioned air that is supplied into the controlled room.

4. The overall efficiency calculating device for an air-conditioning system as set forth in claim 2, wherein the indoor load calculator uses the indoor temperature of the controlled room as a proxy for the indoor entropy and uses the temperature of the conditioned air that is supplied into the controlled room as a proxy for the supply air entropy.

5. The overall efficiency calculating device for an air conditioner as set forth in claim 1, wherein when, there is a plurality of the heat source equipment, the heat source auxiliary equipment, the air conditioners, and the controlled rooms, within the air conditioning system,
the indoor load calculator sums the indoor loads for each of the controlled rooms to calculate a total value for the indoor load within the air conditioning system; and
the overall efficiency calculator calculates the overall efficiency of the air-conditioning system based on the total value for the indoor loads, calculated by the indoor load calculating means, and the total value for the energy usage amount by the heat source equipment, the heat source auxiliary equipment, and the air conditioner.

6. An overall efficiency calculating method for an air conditioner for calculating an overall efficiency as an evaluation metric for an air-conditioning system, applied to an air-conditioning system that comprises heat source equipment for producing chilled/heated water, heat source auxiliary equipment that is provided as auxiliary equipment for the heat source equipment, and an air conditioner for receiving a supply of chilled/heated water from the heat source equipment and for supplying conditioned air into a controlled room, comprising:
an indoor load calculating step calculating an indoor load for the controlled room from, at least, an indoor temperature of the controlled room, a temperature of the conditioned air that is supplied to the controlled room, and a supply rate of the conditioned air that is supplied to the controlled room; and
an overall efficiency calculating step calculating an overall efficiency for the air-conditioning system based on the indoor load that is calculated by the indoor load calculating step, and the total value for the amount of energy used by the heat source equipment, the heat source auxiliary equipment, and the air conditioner.

7. The overall efficiency calculating method for an air-conditioning system as set forth in claim 6, wherein the indoor load calculating step further comprises the step of
calculating an indoor load for the controlled room from indoor entropy for the controlled room, supply air entropy of conditioned air that is supplied into the controlled room, and the amount of supply of the conditioned air supplied into the controlled room.

8. The overall efficiency calculating method for an air-conditioning system as set forth in claim 7, wherein the indoor load calculating step further comprises the step of
calculating the indoor entropy from the indoor temperature and indoor humidity of the controlled room and calculates the supply air entropy from the temperature and humidity of the conditioned air that is supplied into the controlled room.

9. The overall efficiency calculating method for an air-conditioning system as set forth in claim 7, wherein the indoor load calculating step further comprises the step of
using the indoor temperature of the controlled room as a proxy for the indoor entropy and using the temperature of the conditioned air that is supplied into the controlled room as a proxy for the supply air entropy.

10. The overall efficiency calculating step for an air conditioner as set forth in claim 6, wherein:
when, there is a plurality of the heat source equipment, the heat source auxiliary equipment, the air conditioners, and the controlled rooms, within the air conditioning system,
the indoor load calculating step further comprises the step of
summing the indoor loads for each of the controlled rooms to calculate a total value for the indoor load within the air conditioning system; and
the overall efficiency calculating step further comprises the step of
calculating the overall efficiency of the air-conditioning system based on the total value for the indoor loads, calculated by the indoor load calculating step, and the total value for the energy usage amount used by the heat source equipment, the heat source auxiliary equipment, and the air conditioner.
